(19) United States
(12) Patent Application Publication
(10) Pub. No.: US 2021/0093424 A1
(43) Pub. Date: Apr. 1, 2021

(54) DENTAL SCREW

(71) Applicants: Chen-Yi LIN, Taichung City (CN); Jiachang ZHANG, Anaheim, CA (US)

(72) Inventors: Chen-Yi LIN, Taichung City (CN); Jiachang ZHANG, Anaheim, CA (US)

(21) Appl. No.: 17/042,085

(22) PCT Filed: Mar. 21, 2019
(86) PCT No.: PCT/CN2019/000061

§ 371 Date: Sep. 25, 2020

(30) Foreign Application Priority Data
Mar. 26, 2018 (CN) 201820413313.3

(51) Int. Cl. A61C 8/00

(52) U.S. Cl. CPC A61C 8/0068

(57) ABSTRACT

A dental screw for fastening a dental implant and dental abutment is provided. The dental screw comprises a first trough and a second trough. The first trough has a first bottom surface and a pluralities of first laterals, with the first laterals extended and curved shaped. The second trough is disposed on the first bottom surface in stepped shaped. The dental screw of the present invention is to fasten a dental screw into implant through an inclined screw driver, no matter whether the screw driver and the dental screw is coaxial or non-coaxial to each other.

### CROSS-REFERENCE TO RELATED APPLICATION

This application claims priority of International Patent Application Serial No. PCT/CN2019/000061, filed Mar. 21, 2019, which is related to and claims priority of Chinese patent application Serial No. 201820413313.3, filed Mar. 26, 2018. The entirety of each of the above-mentioned patent applications is hereby incorporated herein by reference and made a part of this specification.

### TECHNICAL FIELD

The present invention relates to screw, particularly to the dental screw utilized in fastening dental implant and dental abutment or crown in dental implantation or surgery.

### BACKGROUND

Please refer to FIG. 1, FIG. 1 is schematic diagram of traditional dental screw 10. As shown in FIG. 1, a dental screw 10 includes a head 11 and a rod 12. The head 11 has a hexagonal trough 110 disposed at one end, and thus it needs to utilize a screw driver with hexagonal tip, so as to enter the gexagonal trough 110 and then rotate and fasten the dental screw 10. When the dental screw 10 is utilized, for dental restoration or dental implantation, to fasten dental abutment and implant or crown within patient's mouth, the screw driver will exert a torque force on the hexagonal trough 110 and dental screw 10. Due to each lateral of the hexagonal trough 110 is straight typed, the screw drive cannot have enough contact surface to deliver enough applied force if hexagonal tip of the screw driver is inclinedly engaged with the dental screw 10 (because the screw driver and the dental screw 10 is non-coaxial to each other). Therefore the rotation and fastening of the dental screw 10 are likely ineffective.

In many clinical and practical scenarios, the screw driver needs to engage with the dental screw 10 in an inclined manner, so that it is critical to address this inclined engagement issue for all of those in the skilled of the art.

### SUMMARY

The primary objective of the present invention is to fasten a dental screw into implant through an inclined screw driver, no matter whether the screw driver and the dental screw is coaxial or non-coaxial to each other.

For dealing with those aforementioned issues addressed, the present invention suggests a dental screw for fastening a dental implant and dental abutment. The dental screw comprises a first trough and a second trough. The first trough has a first bottom surface and a pluralities of first laterals, with the first laterals extended and curved shaped. The second trough is disposed on the first bottom surface in stepped shaped.

According to an embodiment of the aforesaid dental screw for fastening a dental implant and dental abutment, wherein the amount of the first laterals are 4 to 8.

According to an embodiment of the aforesaid dental screw for fastening a dental implant and dental abutment, wherein periphery of the first lateral is gradually decreased from the head toward another end of the rod along the axial direction.

According to an embodiment of the aforesaid dental screw for fastening a dental implant and dental abutment, wherein the pluralities of the first laterals connect to each other in a smooth curved manner, or turing point manner.

According to an embodiment of the aforesaid dental screw for fastening a dental implant and dental abutment, wherein the second trough further has a pluralities of second laterals, and the second laterals are extended and curved shaped.

According to an embodiment of the aforesaid dental screw for fastening a dental implant and dental abutment, wherein the second trough is polygon shaped.

According to an embodiment of the aforesaid dental screw for fastening a dental implant and dental abutment, wherein outer surface of the rod has a exterior thread, or, the rod further has a third trough disposed at axial end, with an interior thread formed on the surface of the third trough.

According to an embodiment of the aforesaid dental screw for fastening a dental implant and dental abutment, wherein the second trough further has a second bottom surface, and the rod further has a through hole disposed at end of the rod and connected to the second bottom surface. More specifically, a extending line of the first lateral intersects with the second lateral by an angle θ, and degree of the angle θ is from 20 to 60.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is schematic diagram of traditional dental screw 10.

FIG. 2A is schematic diagram showing perspective view of first embodiment of the dental screw 20.

FIG. 2B is schematic diagram showing section view of the dental screw 20.

FIG. 2C is schematic diagram showing top view of the dental screw 20.

FIG. 3A-3D are schematic diagrams showing the dental screw with different amount of first lateral 211S.

FIG. 4A-4E are schematic diagrams showing the second troughs 212 of multiple shapes.

FIG. 5 is schematic diagram showing the dental screw 20 structurally corresponding to the screw driver 8.

FIG. 6A is schematic diagram showing the dental screw 20 entering the inclined channel 70 of the dental abutment 7.

FIG. 6B is schematic diagram showing that the dental screw 20 is disposed in the inclined channel 70 of the dental abutment 7.

FIG. 6C is schematic diagram showing that the dental abutment 7 and the implant 9 are fastened through the dental screw 20.

FIG. 7A is schematic diagram showing the dental screw 20 entering the inclined channel 60 of the crown 6.

FIG. 7B is schematic diagram showing that the dental screw 20 and the screw driver 8 are disposed in the inclined channel 60 of the crown 6.

FIG. 7C is schematic diagram showing that the crown 6 and the implant 9 are fastened through the dental screw 20.

FIG. 7D is schematic diagram showing that the crown 6 and the implant 9 are fastened in the lower jaw of patient's mouth through the dental screw 20.

FIG. 8A is schematic diagram showing the dental screw 20 entering the vertical channel 610 of the crown 61.

FIG. 8B is schematic diagram showing that the dental screw 20 and the screw driver 82 are disposed in the veritical channel 610 of the crown 61.

FIG. 8C is schematic diagram showing that hexagonal screw driver 82 is disposed in the second trough 212.

FIG. 9A is schematic diagram showing sectional view of second embodiment of the dental screw 30.

FIG. 9B is schematic diagram showing that the dental screw 30 fastened with protruded implant 91.

FIG. 9C is schematic diagram showing that the dental screw 90 is entering the inclined channel 60 of the crown 6.

FIG. 9D is schematic diagram showing that the crown 6 and the implant 91 are fastened through the dental screw 30.

FIG. 10A is schematic diagram showing sectional view of third embodiment of the dental screw 40.

FIG. 10B is schematic diagram showing that the crown 6 and the implant 91 are fastened through the dental screw 40.

FIG. 11 is schematic diagram showing top view of fourth embodiment of the dental screw 50.

FIG. 12A is schematic diagram showing perspective view of fifth embodiment of the dental screw 60.

FIG. 12B is schematic diagram demonstrating that the angle θ is intersected by the second lateral 612S and the extending line of the first lateral 611S.

### DETAILED DESCRIPTION

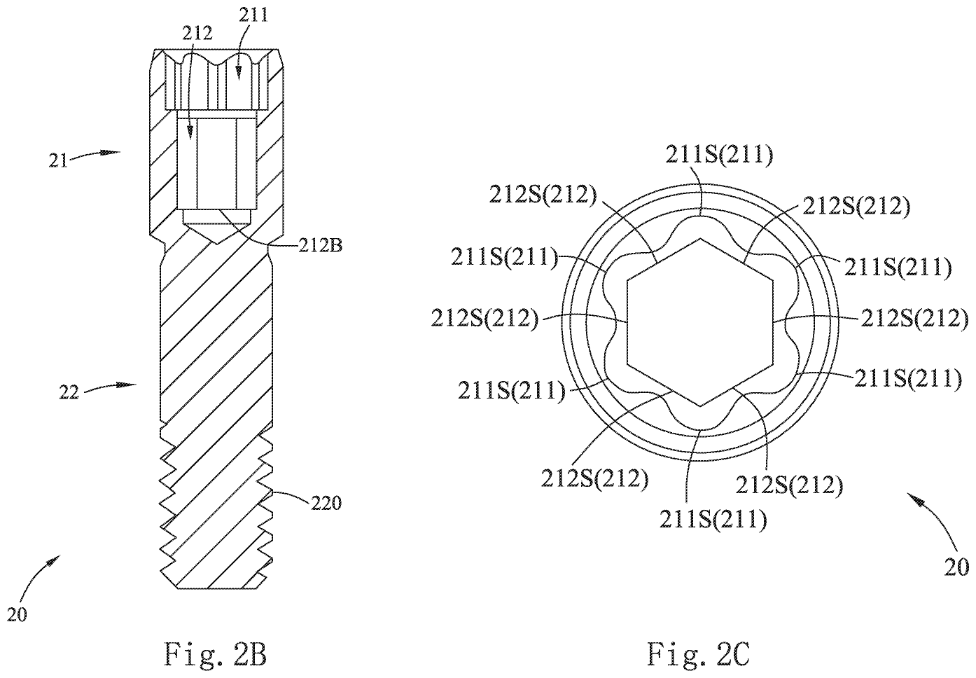

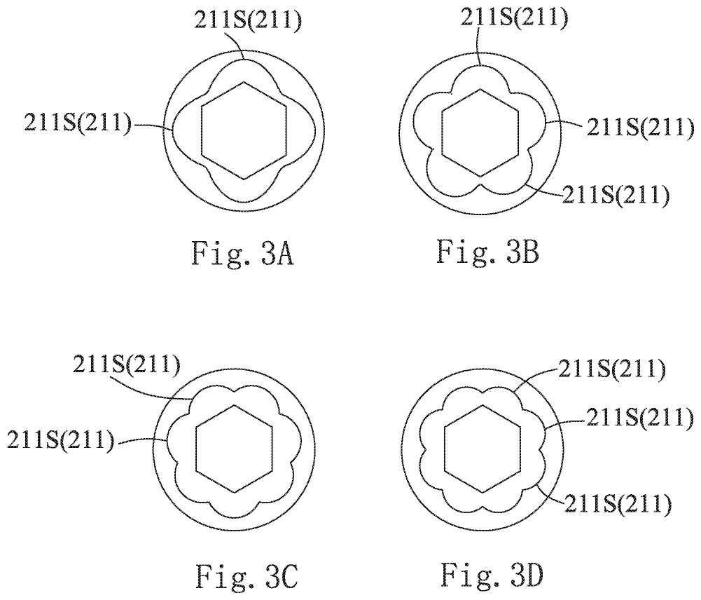

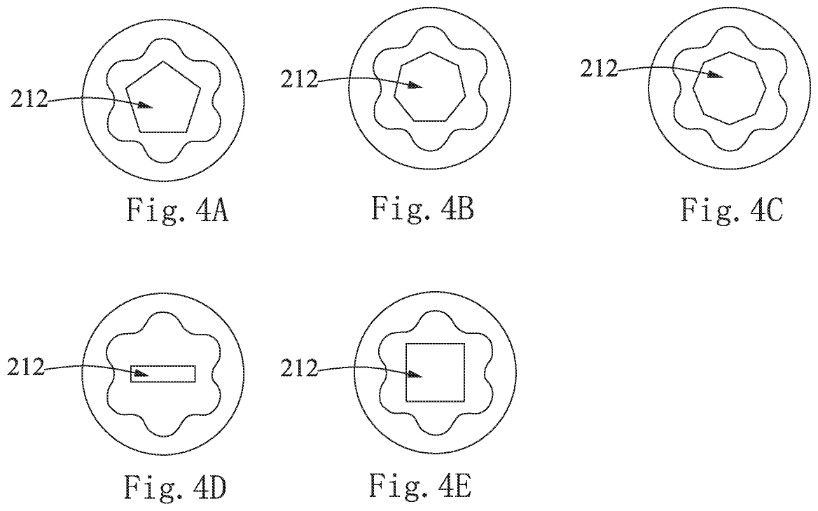

Please refer to FIG. 2A and FIG. 2B, FIG. 2A is schematic diagram showing perspective view of first embodiment of the dental screw 20; FIG. 2B is schematic diagram showing section view of the dental screw 20. As shown in FIG. 2A and 2B, a dental screw 20 has a rod 22, and a head 21 connected to top end of the rod 22. The rod 22 has a exterior thread 220 disposed at outer surface and lower end of the rod 22. The head 21 has a first trough 211 and a second trough 212. The first trough 211 includes a first bottom surface 211B and a pluralities of first laterals 211S. The first laterals 211S are extended and curved shaped. Simultaneously refer to FIG. 2C, where FIG. 2C is schematic diagram showing top view of the dental screw 20; the pluralities of first laterals 211S are connected to each other in a smooth curved manner, thus the first trough 211 has shape of plum blossom through top view. Besides, the second trough 212, disposed on the first bottom surface 211B, has a second bottom surface 212B and a pluralities of second laterals 212S. In the aforementioned diagrams, the dental screw 20 has 6 first laterals 211S; however, those skilled in the art might achieve other amount of first laterals 211S, such as 4, 5, 7 or 8 laterals 211S disposed and demonstrated in FIG. 3A to FIG. 3D. Besides, as shown in FIG. 2C, the second trough 212 is hexagonal cavity; however, those skilled in the art might make the second trough 212 be pentagon cavity, heptagon cavity, octagon cavity, rectangle or square cavity as shown in FIG. 4A to FIG. 4E, in which FIG. 4A-4E are schematic diagrams showing the second troughs 212 of multiple shapes. Those extended embodiments are also have structural feasibility and clinical practicability such that it could be achieved through the dental screw 20 of the present invention.

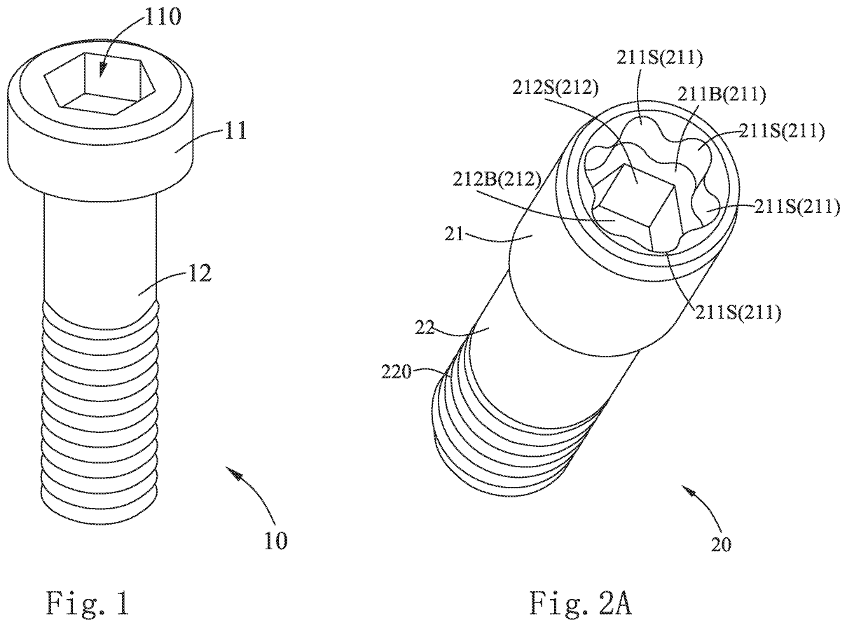

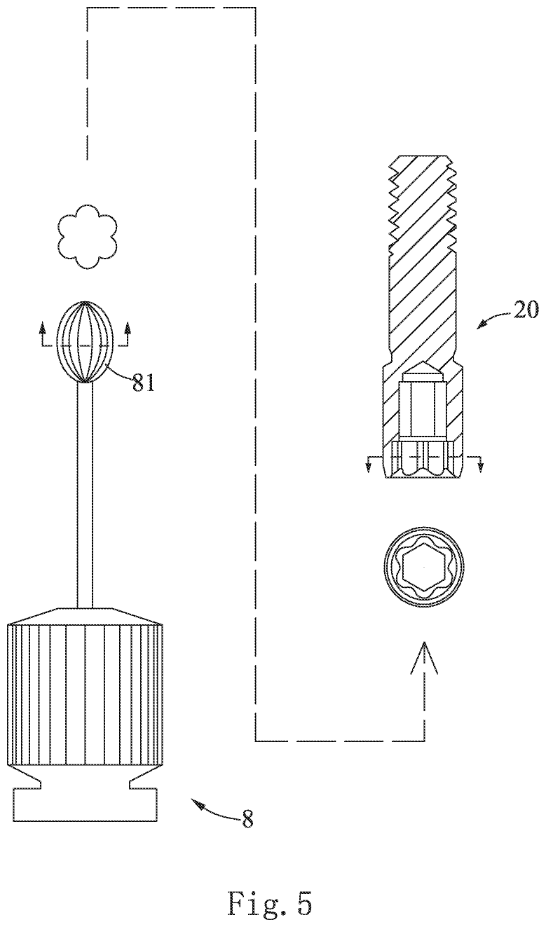

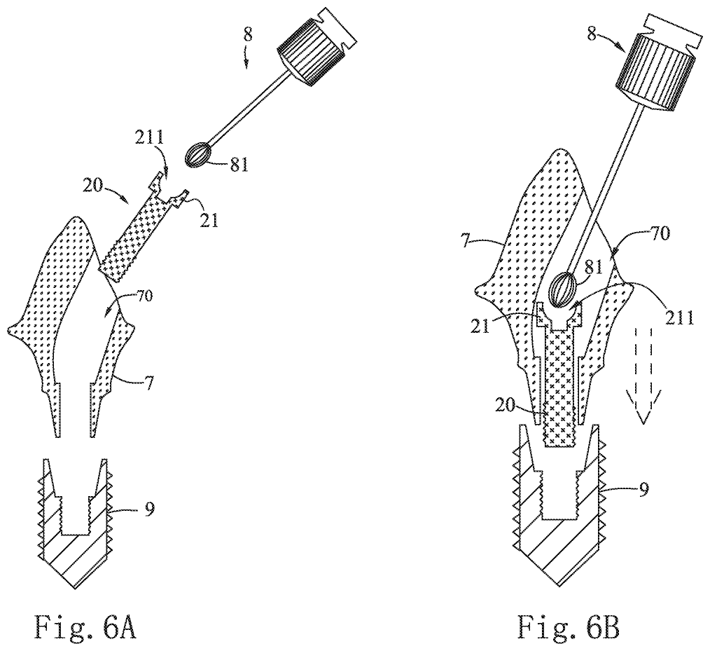

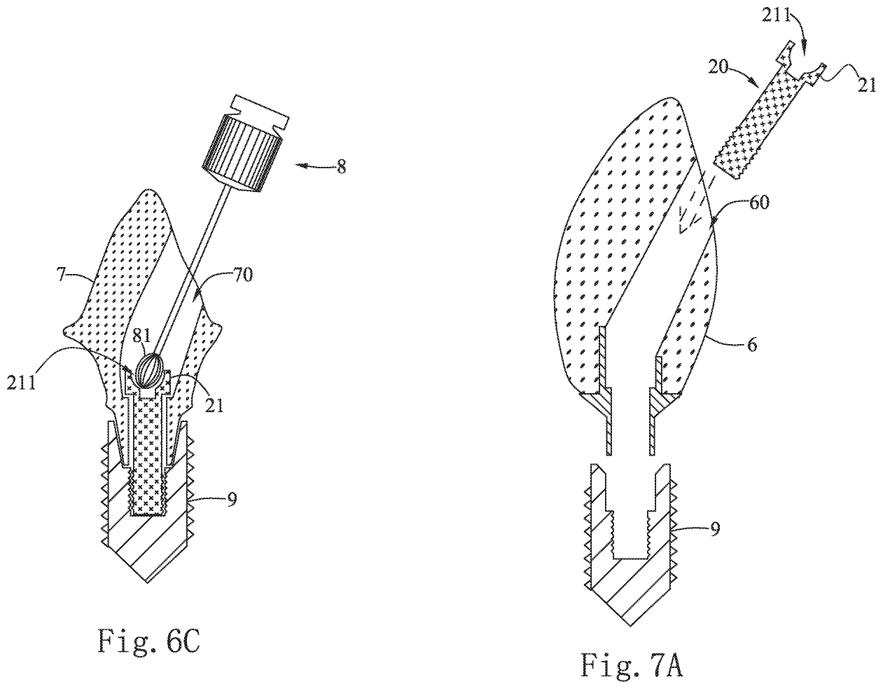

Please refer to FIG. 5, FIG. 5 is schematic diagram showing the dental screw 20 structurally corresponding to the screw driver 8. Due to the first trough 211 of the dental screw 20 is plum blossom shaped cavity, it needs a screw driver 8, equipped with plum blossom shaped tip 81, to engage with and then fasten the dental screw 20. In this manner, even the tip 81 of screw driver 8 are inclinedly (with respect to axial direction of dental screw 20) entered the first trough 211, the tip 81 of screw driver 8 is ensured to have enough applied region to deliver mechanical force within the first trough 211, and thus be able to rotate the dental screw 20. Specifically, the procudure for fastening dental abutment 7 and implant 9 is demonstrated below; please refer to FIG. 6A and FIG. 6B, where FIG. 6A is schematic diagram showing the dental screw 20 entering the inclined channel 70 of the dental abutment 7; FIG. 6B is schematic diagram showing that the dental screw 20 is disposed in the inclined channel 70 of the dental abutment 7. As shown in FIG. 6A-6B, a dental abutment 7 has an inclined channel 70 disposed and passed through. When the dental screw 20 and screw driver 8 enter the inclined channel 70, the screw driver 8 is tilted with respect to the dental screw 20, such that the screw driver 8 and dental screw 20 are non-coaxial. Afterward refer to FIG. 6C, wherein FIG. 6C is schematic diagram showing that the dental abutment 7 and the implant 9 are fastened through the dental screw 20; because of the plum blossom shaped tip 81, the screw driver 8 can engage within the first trough 211 of the head 21 in the inclined manner, so as to rotate and then fasten the dental screw 20. Afterward the dental abutment 7 and the implant 9 are thus combined. Comparing to the traditional dental screw 10 as shown in FIG. 1, which cannot be engaged through an tilted screw driver 8, but the dental screw 20 of present invention is able to be engaged by an tilted screw driver 8. So that rotating the inclined dental screw 20 to fasten the dental abutment 7 and implant 9 is therefore achieved, and hence the dental screw 20 is able to be utilized on the inclined channel 70 of the dental abutment 7.

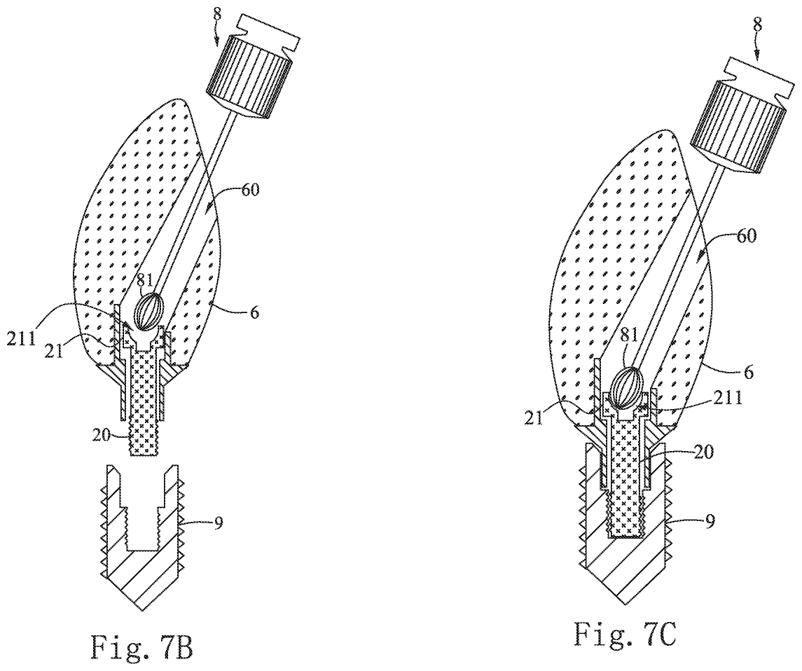

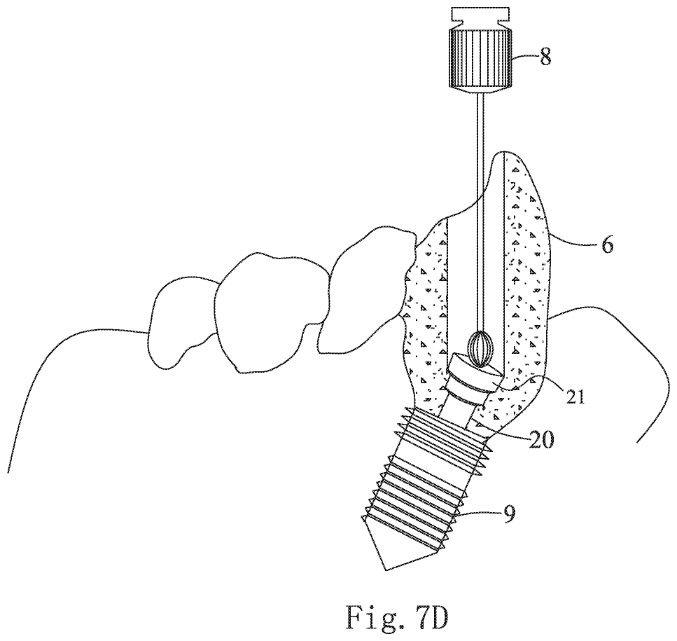

Please refer to FIG. 7A to FIG. 7C, wherein FIG. 7A is schematic diagram showing the dental screw 20 entering the inclined channel 60 of the crown 6; FIG. 7B is schematic diagram showing that the dental screw 20 and the screw driver 8 are disposed in the inclined channel 60 of the crown 6; FIG. 7C is schematic diagram showing that the crown 6 and the implant 9 are fastened through the dental screw 20. As the next embodiment shown in FIG. 7A-7C, the crown 6 has an inclined channel 60, and the screw driver 8 and dental screw 20 are disposed in the inclined channel 60, wherein the screw driver 8 is tilted with respect to the dental screw 20. Because of the plum blossom shaped tip 81 being accessable to engage with the first trough 211, the screw driver 8 is able to rotate and fasten the dental screw 20 in the inclined manner; thus the crown 6 and implant 9 is combined through the dental screw 20. Please refer to FIG. 7D, FIG. 7D is schematic diagram showing that the crown 6 and the implant 9 are fastened in the lower jaw of patient's mouth through the dental screw 20. As shown in FIG. 7D, the screw driver 8 is engaged with the dental screw 20 in the inclined manner, namely tilted screw driver 8 is able to rotate dental screw 20, so as to fasten the crown 6 and implant 9.

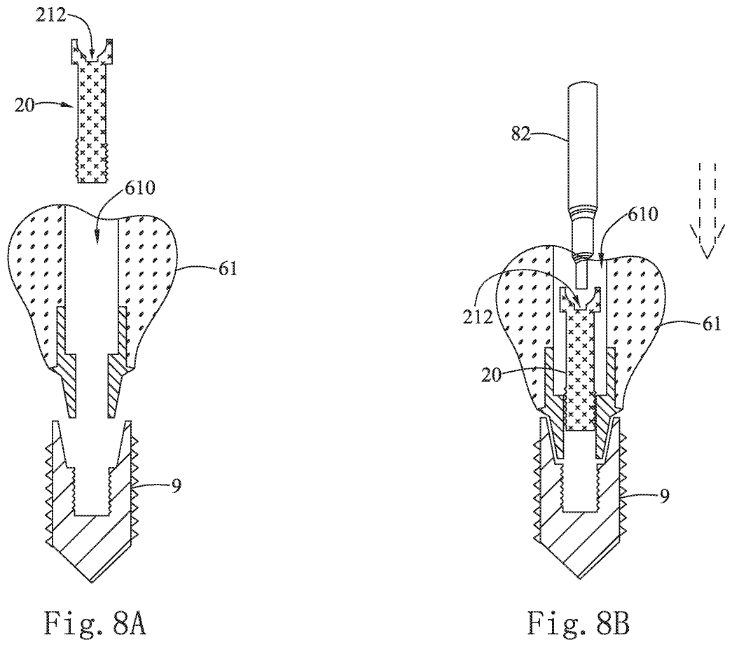

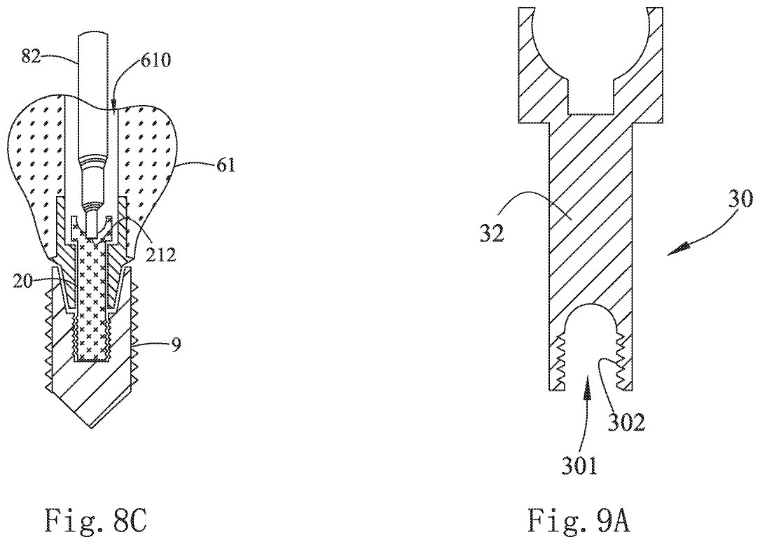

Please refer to FIG. 8A-8C, where FIG. 8A is schematic diagram showing the dental screw 20 entering the vertical channel 610 of the crown 61; FIG. 8B is schematic diagram showing that the dental screw 20 and the screw driver 82 are disposed in the veritical channel 610 of the crown 61; FIG. 8C is schematic diagram showing that hexagonal screw driver 82 is disposed in the second trough 212. As shown in FIG. 8A-8C, the crown 61 has a vertical channel 610, thus hexagonal screw driver 82 can be coaxial with the dental screw 20 when rotating the dental screw 20 needs to be done. In this manner, the screw driver 82 can directly and easily enter the second trough 212, so as to rotate the dental screw 20, and thus fasten the crown 61 and the implant 9.

Therefore, the dental screw 20 of present invention can be utilized in both coaxial manner (demonstrated in FIG. 8A-8C) and tilted manner (demonstrated in FIG. 6A-6C and FIG. 7A-7C), so as to be engaged and rotated by the screw driver 8, 82. Thus, the dental screw 20 can accommodate with both coaxial and intersecting manner to fasten the crown 61 and implant 9, so that the dental screw 20 is able to fasten not only anterior teeth (i.e. canine or incisor) but also posterior teeth (i.e. premolar or molar) if dental implantation is made. In comparison to prior art described as shown in FIG. 1, traditional dental screw 10 has such obvious disadvantage which cannot accommodate for tilted screw driver 8 in fastening.

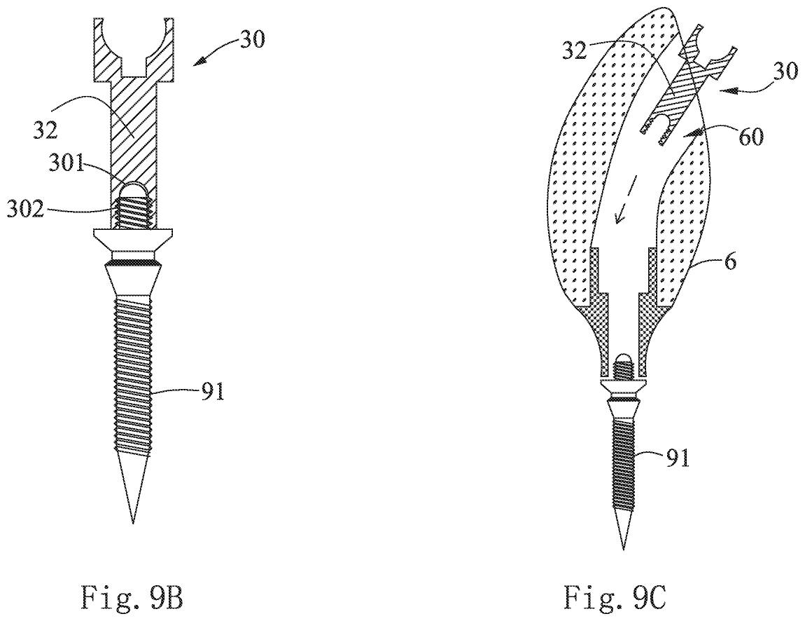

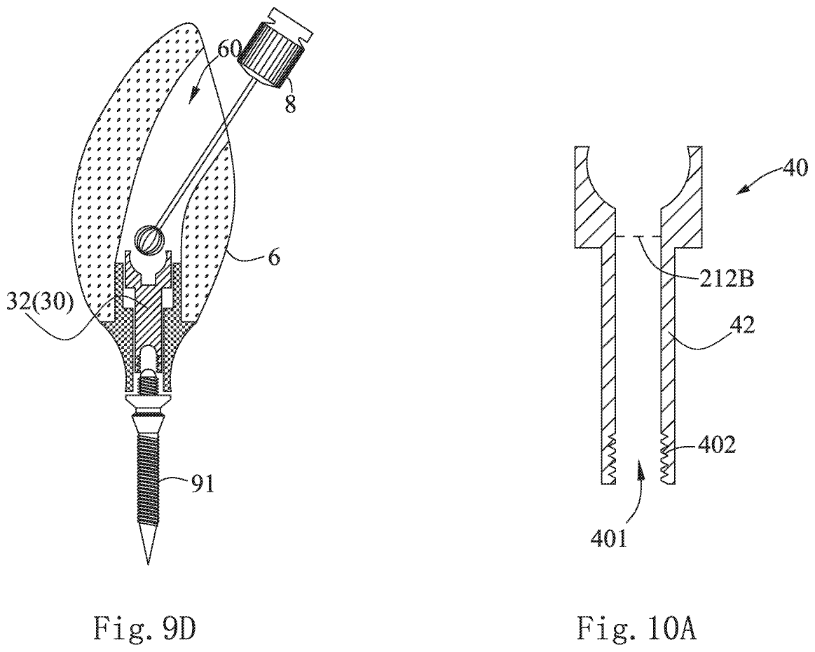

Please refer to FIG. 9A and FIG. 9B, FIG. 9A is schematic diagram showing sectional view of second embodiment of the dental screw 30; FIG. 9B is schematic diagram showing that the dental screw 30 fastened with protruded implant 91. The dental screw 30 has a rod 32 and a third trough 301 disposed at axial end of the rod 32. The dental screw 30 further has an interior thread 302 formed on the surface of the third trough 301. Specifically the dental screw 30 is fastened to one-piece implant 91 through the third trough 301. Further as shown in FIG. 9C and FIG. 9D, the dental screw 30 has entered the inclined channel 60 of the crwon 6, and afterward the crown 6 and the implant 91 are fastened through the dental screw 30.

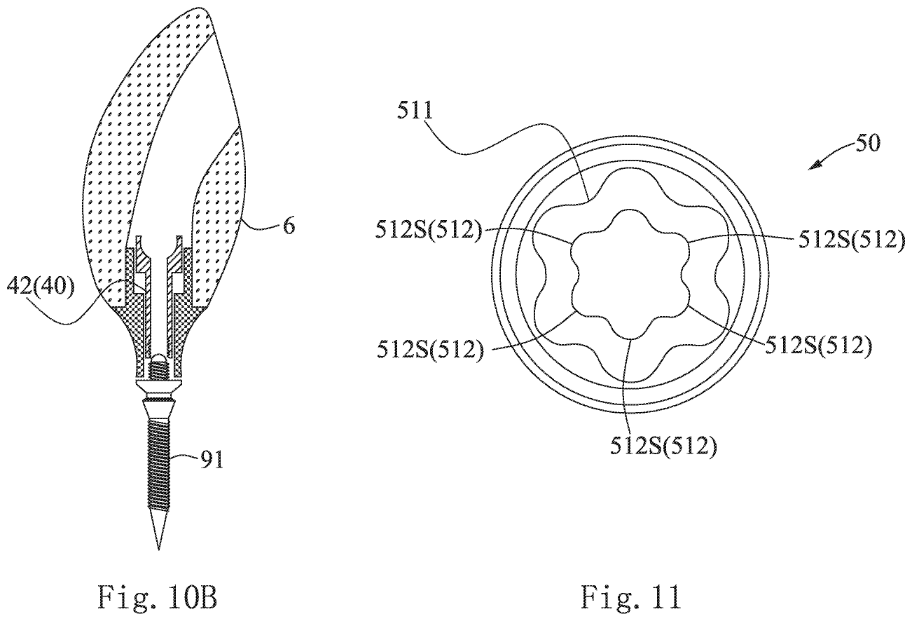

Please refer to FIG. 10A, FIG. 10A is schematic diagram showing sectional view of third embodiment of the dental screw 40. The rod 42 of the dental screw 40 has a through hole 401, in which the through hole 401 passed through the second bottom surface 212B, and an interior thread 402 is formed on surface of axial end of the through hole 401. In this manner, the dental screw 40 is also able to accommodated to one-piece implant 91. When the dental screw 40 is utilized as shown in FIG. 10B, it is revealed that the crown 6 and the implant 91 are hence fastened through the dental screw 40.

Please refer to FIG. 11, FIG. 11 is schematic diagram showing top view of fourth embodiment of the dental screw 50. The dental screw 50 of present invention has a second trough 512, with a pluralities of second laterals 512S extended and curved shaped. Therefore the second trough 512 has apprance of Plum blossom shaped. Besides, the first trough 511 has similar shape to the second trough 512, and hence corresponds to the second trough 512, so as to achieve the same function as aforementioned.

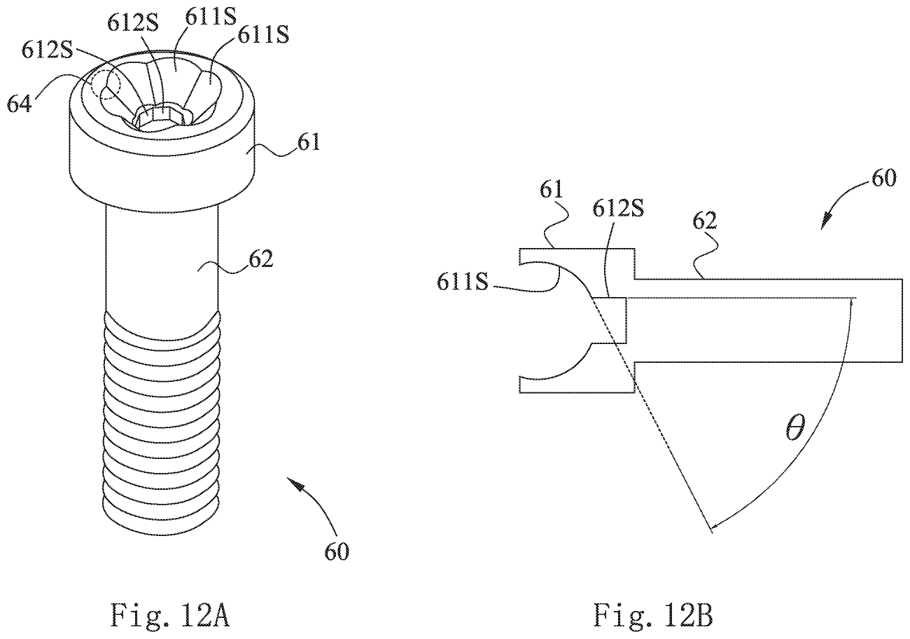

Please refer to FIG. 12A, FIG. 12A is schematic diagram showing perspective view of fifth embodiment of the dental screw 60. As shown in FIG. 12A, the dental screw 60 of present invention has a pluralities of first laterals 611S, and the periphery of the first laterals 611S are gradually decreased from the head 61 toward lower end of the rod 62 along the axial direction. In this embodiment, the pluralities of the first laterals 611S connect to each other in a turing point 64 manner. Different contour of first laterals 611S can accommodate to engage with more types of screw driver 8, 82. Please refer to FIG. 12B, FIG. 12B is schematic diagram demonstrating that the angle θ is intersected by the second lateral 612S and the extending line of the first lateral 611S. As shown in FIG. 12B, a extending line of the first lateral 611S intersects with the second lateral 612S by an angle θ. Normally the degree of the angle θ is about 20 to 60.

Summarily, the dental screw 20, 30, 40, 50, 60 of present invention can be engaged and rotated by screw driver 8, 82 in both tilted and coaxial manner, so that it is able to accommodate for dental implantation in not only anterior teeth (i.e. canine or incisor) but also posterior teeth (i.e. premolar or molar). Moreover, the dental screw 20, 30, 40, 50, 60 of present invention can also be utilized for one-piece implant 91. Therefore, the present invention has broader feasibility, and can accommodate for more types of implant, so that has clinical and commercial value.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A dental screw for fastening a dental implant and dental abutment, having a rod and a head disposed at one end of the rod, the dental screw comprising:
a first trough, having a first bottom surface and a pluralities of first laterals, with the first laterals extended and curved shaped;
a second trough, disposed on the first bottom surface in stepped shaped.

2. The dental screw according to claim 1, wherein the amount of the first laterals are 4 to 8.

3. The dental screw according to claim 1, wherein the pluralities of the first laterals connect to each other in a smooth curved manner, or turing point manner.

4. The dental screw according to claim 1, wherein the second trough further has a pluralities of second laterals, and the second laterals are extended and curved shaped.

5. The dental screw according to claim 1, wherein the second trough is polygon shaped.

6. The dental screw according to claim 1, wherein outer surface of the rod has a exterior thread, or, the rod further has a third trough disposed at axial end, with an interior thread formed on the surface of the third trough.

7. The dental screw according to claim 1, wherein the second trough further has a second bottom surface, and the rod further has a through hole disposed at end of the rod and connected to the second bottom surface.

8. The dental screw according to claim 1, wherein periphery of the first lateral is gradually decreased from the head toward another end of the rod along the axial direction.

9. The dental screw according to claim 8, wherein a extending line of the first lateral intersects with the second lateral by an angle θ.

10. The dental screw according to claim 9, wherein degree of the angle θ is from 20 to 60.
